(19) United States
(12) Patent Application Publication
(10) Pub. No.: US 2014/0345739 A1
(43) Pub. Date: Nov. 27, 2014

(54) FLEXIBLE PIPE BODY AND METHOD OF MANUFACTURE

(71) Applicant: Geoffrey Stephen Graham, Newcastle-Upon-Tyne (GB)

(72) Inventor: Geoffrey Stephen Graham, Newcastle-Upon-Tyne (GB)

(21) Appl. No.: 14/364,716

(22) PCT Filed: Dec. 12, 2012
(86) PCT No.: PCT/GB2012/053108

§ 371 Date: Jun. 12, 2014

(30) Foreign Application Priority Data
Dec. 29, 2011 (GB) 1122436.7

(51) Int. Cl. F16L 11/18

(52) U.S. Cl. CPC F16L 11/18
USPC 138/120; 29/527.1

(57) ABSTRACT

A flexible pipe body and method of manufacturing a flexible pipe body are disclosed. The pipe body includes a carcass layer (303) including a plurality of adjacent interlocked annular elements (301), each annular element comprising a main body portion communicating with a male connection region and a female connection region, the male connection region for interlocking with a corresponding female connection region of an adjacent annular element and the female connection region for interlocking with a corresponding male connection region of an adjacent annular element, and a filler material filling an annulus area defined by the main body portion, male connection region and female connection region.

The present invention relates to a flexible pipe body and a method of manufacture. In particular, but not exclusively, the present invention relates to a flexible pipe body having a low cost carcass layer useful in adding weight to the flexible pipe body.

Traditionally flexible pipe is utilised to transport production fluids, such as oil and/or gas and/or water, from one location to another. Flexible pipe is particularly useful in connecting a sub-sea location (which may be deep underwater, say 1000 metres or more) to a sea level location. The pipe may have an internal diameter of typically up to around 0.6 metres. Flexible pipe is generally formed as an assembly of a flexible pipe body and one or more end fittings. The pipe body is typically formed as a combination of layered materials that form a pressure-containing conduit. The pipe structure allows large deflections without causing bending stresses that impair the pipe's functionality over its lifetime. The pipe body is generally built up as a combined structure including metallic and polymer layers.

Unbonded flexible pipe has been used for deep water (less than 3,300 feet (1,005.84 metres)) and ultra deep water (greater than 3,300 feet) developments. It is the increasing demand for oil which is causing exploration to occur at greater and greater depths where environmental factors are more extreme. For example in such deep and ultra-deep water environments ocean floor temperature increases the risk of production fluids cooling to a temperature that may lead to pipe blockage. Increased depths also increase the pressure associated with the environment in which the flexible pipe must operate. As a result the need for high levels of performance from the layers of the flexible pipe body is increased.

Flexible pipe may also be used for shallow water applications (for example less than around 500 metres depth) or even for shore (overland) applications.

Rough bore and smooth bore flexible pipes are known. Smooth bore flexible pipe includes a fluid retaining layer called a liner. A smooth inner surface of the liner defines a bore along which fluid is transported. Smooth bore flexible pipes are used in various applications, such as for water injection, or for shallow water applications. However, on occasion when a bore is depressurised an accumulated pressure in an annulus region of the flexible pipe between the liner and a radially outer layer can cause the liner to collapse and this leads to irreversible damage. Therefore in some applications a carcass layer is used inside the fluid retaining layer. This is a so-called rough bore application and the carcass layer, which is often formed by helically winding shaped strips in an interlocked fashion, prevents collapse of the fluid retaining layer under depressurisation of the bore by supporting the fluid retaining layer. When a carcass is used the fluid retaining layer is termed a barrier layer. In some applications a vent valve may be used such that when pressure of trapped gas in the annulus region reaches a predetermined level (e.g. 3 bar), the gas is vented away or back into the bore region.

Known carcass layers generally give a less smooth finish to the inner surface of the pipe body, which can adversely affect fluid flow through the pipe.

In some smooth bore flexible pipe assemblies for shallow water applications, a problem can arise when the pipe is too buoyant for the surroundings, and can pop up and float on the surface of the water, which can be undesirable for the users.

It is an aim of the present invention to at least partly mitigate the above-mentioned problems.

It is an aim of embodiments of the present invention to provide a flexible pipe body with an economically priced collapse resistant layer.

It is an aim of embodiments of the present invention to provide a flexible pipe body with increased weight without significantly increasing costs or complexity of manufacture.

It is an aim of embodiments of the present invention to provide a flexible pipe body that has a higher collapse resistance than a smooth bore pipe for minimal extra cost.

According to a first aspect of the present invention there is provided a flexible pipe body, comprising:
a carcass layer including a plurality of adjacent interlocked annular elements, each annular element comprising
   a main body portion communicating with a male connection region and a female connection region, the male connection region for interlocking with a corresponding female connection region of an adjacent annular element and the female connection region for interlocking with a corresponding male connection region of an adjacent annular element, and
      a filler material filling an annulus area defined by the main body portion, male connection region and female connection region

According to a second aspect of the present invention there is provided a method of manufacturing a flexible pipe body, comprising:
providing a plurality of annular elements comprising
   a main body portion communicating with a male connection region and a female connection region, the male connection region for interlocking with a corresponding female connection region of an adjacent annular element and the female connection region for interlocking with a corresponding male connection region of an adjacent annular element, and
   a filler material filling an annulus area defined by the main body portion, male connection region and female connection region; and
interlocking a first of the plurality of annular elements with a further, adjacent annular element by urging one of the male or female connection portions with a corresponding respective female or male connection portion of the adjacent annular element.

Certain embodiments of the invention provide the advantage that a flexible pipe body is produced that has a layer resistant to collapse for an economical price. Certain embodiments of the invention provide the advantage that a flexible pipe body is produced that can resist the pressures that would normally collapse a smooth bore pipe, yet has a relatively smooth radially innermost layer. Certain embodiments of the invention provide the advantage that the carcass layer can be used to also add weight to the flexible pipe body. This may help to stabilize flexible pipe in shallow water for example.

Embodiments of the invention are further described hereinafter with reference to the accompanying drawings, in which:

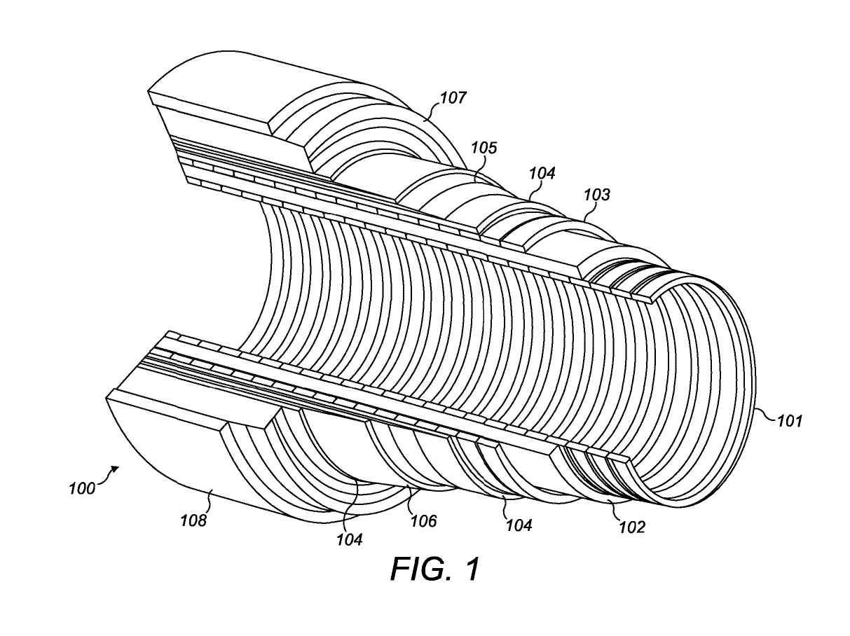

FIG. 1 illustrates a flexible pipe body;

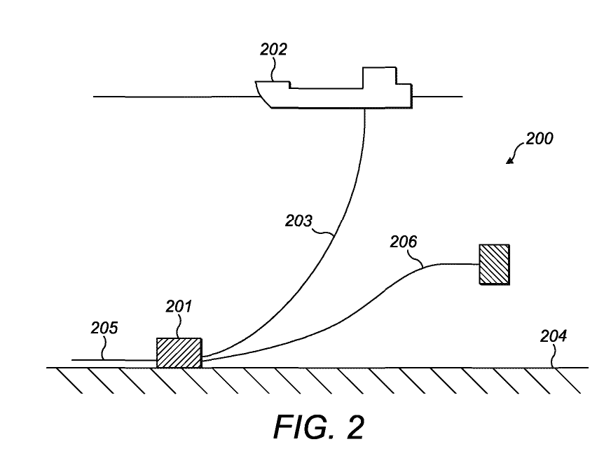

FIG. 2 illustrates a riser assembly,

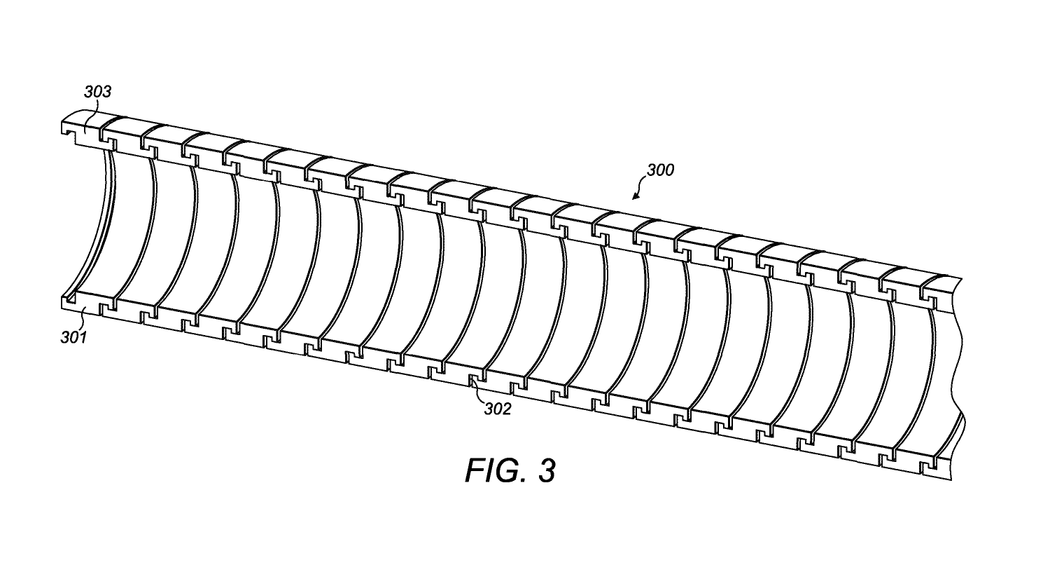

FIG. 3 illustrates a carcass layer;

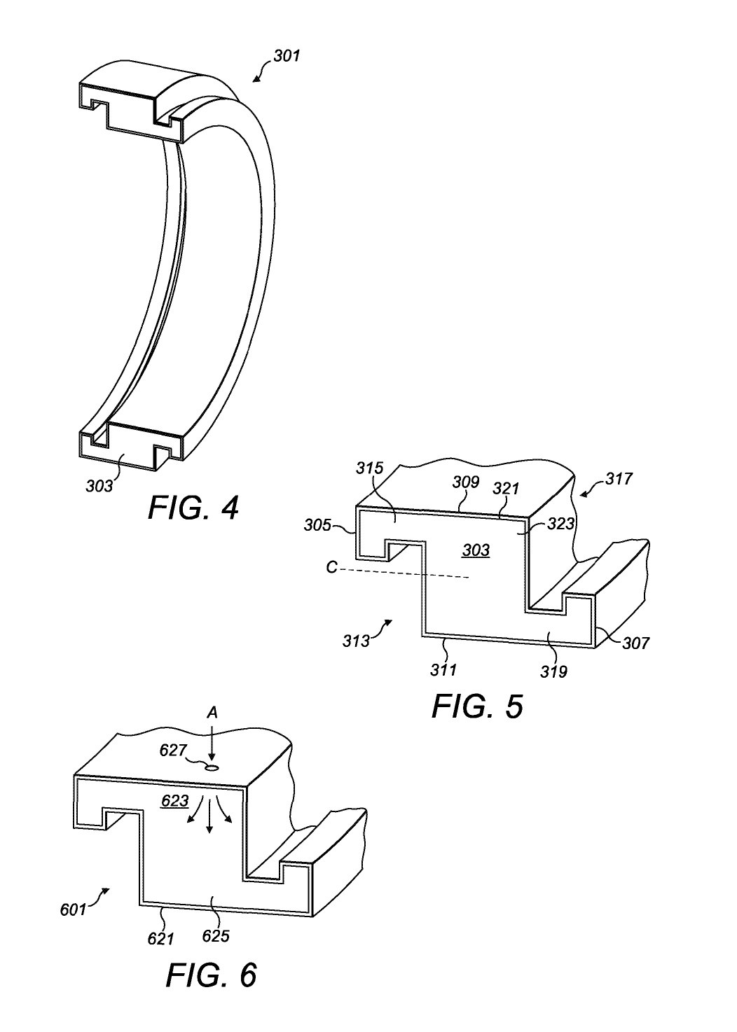

FIG. 4 illustrates an annular element in cutaway;

FIG. 5 illustrates an expanded view of the annular element of FIG. 4; and

FIG. 6 illustrates an annular element being formed.

In the drawings like reference numerals refer to like parts.

Throughout this description, reference will be made to a flexible pipe. It will be understood that a flexible pipe is an assembly of a portion of a pipe body and one or more end fittings in each of which a respective end of the pipe body is terminated. FIG. 1 illustrates how pipe body 100 is formed in accordance with an embodiment of the present invention from a combination of layered materials that form a pressure-containing conduit. Although a number of particular layers are illustrated in FIG. 1, it is to be understood that the present invention is broadly applicable to coaxial pipe body structures including two or more layers manufactured from a variety of possible materials. It is to be further noted that the layer thicknesses are shown for illustrative purposes only.

As illustrated in FIG. 1, a pipe body includes an optional innermost carcass layer 101. The carcass provides an interlocked construction that can be used as the innermost layer to prevent, totally or partially, collapse of an internal pressure sheath 102 due to pipe decompression, external pressure, and tensile armour pressure and mechanical crushing loads. It will be appreciated that certain embodiments of the present invention are applicable to smooth bore operations (i.e. without a carcass) as well as such rough bore applications.

The internal pressure sheath 102 acts as a fluid retaining layer and comprises a polymer layer that ensures internal fluid integrity. It is to be understood that this layer may itself comprise a number of sub-layers.

An optional pressure armour layer 103 is a structural layer with a lay angle close to 90° that increases the resistance of the flexible pipe to internal and external pressure and mechanical crushing loads. The layer also structurally supports the internal pressure sheath, and typically consists of an interlocked construction.

The flexible pipe body also includes an optional first tensile armour layer 105 and optional second tensile armour layer 106. Each tensile armour layer is a structural layer with a lay angle typically between 10° and 55°. Each layer is used to sustain tensile loads and internal pressure. The tensile armour layers are often counter-wound in pairs.

The flexible pipe body shown also includes optional layers of tape 104 which help contain underlying layers and to some extent prevent abrasion between adjacent layers.

The flexible pipe body also typically includes optional layers of insulation 107 and an outer sheath 108, which comprises a polymer layer used to protect the pipe against penetration of seawater and other external environments, corrosion, abrasion and mechanical damage.

Each flexible pipe comprises at least one portion, sometimes referred to as a segment or section of pipe body 100 together with an end fitting located at at least one end of the flexible pipe. An end fitting provides a mechanical device which forms the transition between the flexible pipe body and a connector. The different pipe layers as shown, for example, in FIG. 1 are terminated in the end fitting in such a way as to transfer the load between the flexible pipe and the connector.

FIG. 2 illustrates a riser assembly 200 suitable for transporting production fluid such as oil and/or gas and/or water from a sub-sea location 201 to a floating facility 202. For example, in FIG. 2 the sub-sea location 201 includes a sub-sea flow line. The flexible flow line 205 comprises a flexible pipe, wholly or in part, resting on the sea floor 204 or buried below the sea floor and used in a static application. The floating facility may be provided by a platform and/or buoy or, as illustrated in FIG. 2, a ship. The riser assembly 200 is provided as a flexible riser, that is to say a flexible pipe 203 connecting the ship to the sea floor installation. The flexible pipe may be in segments of flexible pipe body with connecting end fittings.

It will be appreciated that there are different types of riser, as is well-known by those skilled in the art. Embodiments of the present invention may be used with any type of riser, such as a freely suspended (free, catenary riser), a riser restrained to some extent (buoys, chains), totally restrained riser or enclosed in a tube (I or J tubes).

FIG. 2 also illustrates how portions of flexible pipe can be utilised as a flow line 205 or jumper 206.

FIG. 3 illustrates a cut-away portion of a carcass layer 300 of a flexible pipe body according to the present invention. The carcass layer is formed from a plurality of hoops or annular elements 301, an expanded view of a cutaway hoop 301 being shown in FIG. 4, and a further expanded view of the profile being shown in FIG. 5.

Multiple hoops may be aligned next to each other in a side-by-side coaxial relationship. The independent hoops can be interlocked together with adjacent hoops being interlocked together so as to form a carcass layer of a flexible pipe body.

Each hoop 301 includes a main body portion 303 that is generally rectangular in cross-section. The profile of the cross-section has a substantially block-like nature with a first side wall 305 and a second, spaced apart and substantially parallel, side wall 307 arranged substantially perpendicular to a lower surface 309 that is substantially parallel to but spaced apart from a further upper surface 311. The side walls, and upper and lower surfaces form an imaginary rectangle. A corner region of the profile provides a “cut out” region 313. The cut out region provides a hooked region 315 extending outwardly from the main body portion 303 and then downwardly towards an imaginary centre line C. At a diametrically opposite corner region of the profile there is a further cut out region 317. The cut out region 317 provides a further hooked region 319 extending outwardly from the main body portion 303 and then upwardly towards the imaginary centre line C. However, as used herein, for clarity the further hooked region 319 will be labelled a valley region 319 so as to help distinguish the two regions 315,319. As such, the valley region 319 is essentially the same shape, but a radially rotated profile of the hooked region 315.

As shown in FIGS. 4 and 5, the hoop 301 is formed of a casing 321, which in this case is of HDPE, surrounding a filler material 323, which in this case is cement. Although the filler material is described here as cement, any appropriate filler material may be used. The filler material may be a low cost, heavy material, such as concrete, aggregate, metal powder, glass, sand, ceramic, gypsum, or the like, with or without a resin or ceramic binder, or a combination thereof. The term ‘heavy’ is used in its most general sense to mean having a density higher than the density of water, i.e. to offset the buoyancy of the pipe structure to a level that would create sufficient stability to prevent undue movement of the pipe in use. Aptly, the density of the material could be a density that is equal to or higher than the density of water and equal to or lower than twice the density of water, at the temperature of use. The use of HDPE or other relatively low cost material for the casing also helps with cost efficiency.

As the carcass layer is manufactured, a hook region of a hoop nests within a valley region of an adjacent hoop.

A method of manufacturing flexible pipe body according to an embodiment of the present invention will now be described with reference to FIG. 6. In a first step, a plurality of annular elements (hoops) are formed. Each hoop 601 may be fabricated in accordance with those described above with reference to FIGS. 3, 4 and 5.

An outer casing 621 is first manufactured from HDPE using blow moulding techniques. The casing forms a continuous overall ring shape having a void 625 running therethrough. An aperture 627 is left in the casing 621 after forming the remaining part of the casing.

Then, a cement filler mixture 623 in a flowable form is introduced through the aperture 627 in the direction of arrow A. The cement 623 is pumped into the casing until it fills all or a substantial part of the casing, extending into the body portion, the hook region and the valley region, all away around the annular element.

Then, the annular elements are aligned in a side-by-side coaxial relationship and interlocked by urging a hooked portion of a first annular element with a corresponding valley portion of an adjacent annular element, and so on until a layer similar to that shown in FIG. 3 is achieved. It will be appreciated that since the HDPE material will have some plasticity/flexibility, and the cement filler is in a flowable (non-set) form, the hooked and valley regions will be pliable enough to be urged together and nest into place (with a hooked portion of one hoop sitting in a cut out portion of an adjacent hoop).

Subsequently, when the cement filler hardens, the interlock is sufficiently permanent that the adjacent annular elements cannot become freed from their neighbouring elements. However, the annular elements may be formed such that there is a degree of lateral movement between hoops in a direction along the longitudinal axis of the pipe body (see gap 302 in FIG. 3 between adjacent hoops).

Whilst the cement is hardening, the resilience of the HDPE casing is sufficient to maintain the connection between hoops and limit any excess movement to ensure a secure interlock.

Upon being set, the filler 623 affords the layer with a secure and permanent interlock, suitable collapse resistance, and adds weight to the overall pipe structure.

Each independent hoop in the carcass layer forms an annular element which thus extends around a circumference of a bore region. Since the inner surface of each hoop profile is flat, the surface of the carcass layer facing the bore region will be relatively smooth compared to known carcass layers.

In an alternative embodiment, the filler material could be the first formed portion of each annular element, by moulding into shape and hardening for example. Then, the outer casing could be over-moulded, preferably whilst the filler has some degree of flexibility. Then, the annular elements could be interlocked as above.

With the above-described flexible pipe body, there is provided a cost efficient, “semi-rough bore” pipe that has increased resistance to pressure from gas build up in the annulus, yet has a smoother internal surface for improved flow characteristics compared to known carcass layers.

Various modifications to the detailed designs as described above are possible. For example, although the cross-sectional profile of the hoops have been described to include a hooked region and a valley region for enabling interlocking with adjacent hoops, it will be realised that any suitable male-female connection system may be used, such as spigots and lips or otherwise.

Although the casing is described as formed of HDPE, any suitable material may be used, such as a polymer or composite material. Although the casing has been described to be formed as a single, unitary piece for each annular element, the casing could equally be formed from two or more separate portions that are bonded together to form the whole casing.

Although the filler material of the annular elements has been described in terms of a heavy and/or low cost filler, alternatively an insulator material could be used such as syntactic foam or beads or aerogel. As a further addition, a polymer sheath could be extruded over this carcass layer. The insulator material would provide a higher level of insulation radially inwards of the pressure armour, making it possible to use lower temperature materials in the radially outer layers of the pipe. Further layers of the pipe body can also be added similarly to those shown in FIG. 1, for example.

Although the method described above uses blow moulding to form the casing, it would also be possible to use compression moulding, injection moulding, rotational moulding, or the like.

It will be clear to a person skilled in the art that features described in relation to any of the embodiments described above can be applicable interchangeably between the different embodiments. The embodiments described above are examples to illustrate various features of the invention.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A flexible pipe body, comprising:
a carcass layer including a plurality of adjacent interlocked annular elements, each annular element comprising
a main body portion communicating with a male connection region and a female connection region, the male connection region for interlocking with a corresponding female connection region of an adjacent annular element and the female connection region for interlocking with a corresponding male connection region of an adjacent annular element, and
a filler material filling an annulus area defined by the main body portion, male connection region and female connection region.

2. A flexible pipe body as claimed in claim 1, wherein the male connection region comprises a hooked region and the female connection region comprises a valley region.

3. A flexible pipe body as claimed in claim 1, wherein the annular elements comprise a polymer or composite casing forming the main body portion, the male connection region and the female connection region.

4. A flexible pipe body as claimed in claim 3 wherein the casing comprises HDPE.

5. A flexible pipe body as claimed in claim 1, wherein the filler material comprises a material with a density that is equal to or higher than the density of water and equal to or lower than twice the density of water, at the temperature of use.

6. A flexible pipe body as claimed in claim 1 wherein the filler material comprises concrete, cement, aggregate, metal powder, glass, sand, ceramic, gypsum, or the like, with or without a resin or ceramic binder, or a combination thereof.

7. A flexible pipe body as claimed in claim 1, wherein the filler material comprises an insulator material.

8. A flexible pipe body as claimed in claim 7 wherein the insulator material is a syntactic foam or beads, or aerogel.

9. A flexible pipe body as claimed in claim 1 wherein the plurality of annular elements each comprise an independent hoop element provided in a side-by-side coaxial relationship along a bore region of the flexible pipe body.

10. A method of manufacturing a flexible pipe body, comprising:
providing a plurality of annular elements comprising
a main body portion communicating with a male connection region and a female connection region, the male connection region for interlocking with a corresponding female connection region of an adjacent annular element and the female connection region for interlocking with a corresponding male connection region of an adjacent annular element, and
a filler material filling an annulus area defined by the main body portion, male connection region and female connection region; and
interlocking a first of the plurality of annular elements with a further, adjacent annular element by urging one of the male or female connection portions with a corresponding respective female or male connection portion of the adjacent annular element.

11. A method as claimed in claim 10 wherein the step of providing the plurality of annular elements comprises providing a casing to define the annulus area, and then filling the casing with the filler material.

12. A method as claimed in claim 11, wherein the casing is moulded by blow moulding, compression moulding, injection moulding or rotational moulding.

13. A method as claimed in claim 12 wherein the casing is moulded as a unitary piece.

14. A method as claimed in claim 10 wherein the step of providing the plurality of annular elements comprises first forming the filled annulus area as a hoop element having the main body portion, male connection region and female connection region, and then providing a casing around the hoop element.

15. A method as claimed in claim 14 wherein the casing is moulded around the hoop element by compression moulding or injection moulding.

16. A method as claimed in claim 10 wherein the male connection region comprises a hooked region and the female connection region comprises a valley region.

17. A method as claimed in claim 11 wherein the casing comprises polymer or composite material.

18. A method as claimed in claim 17 wherein the casing comprises HDPE.

19. A method as claimed in claim 10 wherein the filler material comprises a material with a density that is equal to or higher than the density of water and equal to or lower than twice the density of water, at the temperature of use.

20. A method as claimed in claim 10 wherein the filler material comprises concrete, cement, aggregate, metal powder, glass, sand, ceramic, gypsum, or the like, with or without a resin or ceramic binder, or a combination thereof

21. A method as claimed in claim 10 wherein the filler material comprises an insulator material.

22. A method as claimed in claim 21 wherein the insulator material is a syntactic foam or beads, or aerogel.

23.-24. (canceled)
